(19) United States
(12) Patent Application Publication
(10) Pub. No.: US 2007/0123133 A1
(43) Pub. Date: May 31, 2007

(54) OLED devices with color filter array units

(75) Inventor: Dustin L. Winters, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 11/289,986

(22) Filed: Nov. 30, 2005

(51) Int. Cl. H01J 9/24; H01J 9/00

(52) U.S. Cl. 445/24

(57) ABSTRACT

A method of fabricating a plurality of OLED devices, wherein each OLED device includes a light-producing unit and a color filter array unit, including providing a first substrate in a controlled environment and forming a plurality of light-producing units on a first side of such first substrate, with each light-producing unit having an array of pixels; scribing under a controlled environment the first substrate to provide a plurality of individual light-producing units; testing under a controlled environment the plurality of light-producing units before or after scribing to identify acceptable light-producing units; providing a second substrate having an acceptable color filter array unit formed on a first side of the second substrate; bonding the acceptable color filter array unit to an acceptable individual light-producing unit to form a bonded unit such that the first side of the first substrate is adjacent to the first side of the second substrate.

### CROSS REFERENCE TO RELATED APPLICATIONS

Reference is made to commonly assigned U.S. patent application Ser. No. 11/116,743, filed Apr. 28, 2005, by Winters et al., entitled “Encapsulating Emissive Portions Of An OLED Device” and U.S. patent application Ser. No. 10/899,902, filed Jul. 27, 2004 by Boroson, entitled “Desiccant For Top-Emitting OLED”; the disclosures of which are incorporated herein by reference.

### FIELD OF THE INVENTION

The present invention relates to fabricating OLED devices.

### BACKGROUND OF THE INVENTION

In the simplest form, an organic electroluminescent (EL) device is comprised of an organic electroluminescent media disposed between first and second electrodes serving as an anode for hole injection and a cathode for electron injection. The organic electroluminescent media supports recombination of holes and electrons that yields emission of light. These devices are also commonly referred to as organic light-emitting diodes, or OLEDs. A basic organic EL element is described in U.S. Pat. No. 4,356,429. In order to construct a pixilated OLED display that is useful as a display such as, for example, a television, computer monitor, cell phone display, or digital camera display, individual organic EL elements can be arranged as pixels in a matrix pattern. These pixels can all be made to emit the same color, thereby producing a monochromatic display, or they can be made to produce multiple colors such as a three-pixel red, green, blue (RGB) display.

OLED displays have been fabricated with active matrix (AM) driving circuitry in order to produce high performance displays. Such a display is disclosed in U.S. Pat. No. 5,550,066. However, in this type of display, when light is emitted downward through the substrate, the overall area that can emit light is limited by the presence of thin film transistors (TFT's) and other circuitry, which are opaque. The area of the display pixels that emits light relative to the total area of the pixels is known as the aperture ratio (AR) and is typically less than 50% in such displays. In order to compensate for lower AR, the device must be driven at a higher current density compared to a device with a high AR. The result is that the lower-AR devices use more power and have a shorter useable life than a device with a higher AR.

Therefore, much work has been done to produce AM OLED displays that are top- or surface-emitting, that is, where light is removed through the upper surface away from the substrate and TFT circuitry. Such a device is described in EP 1 102 317. This allows for improved AR and therefore improved performance of the display.

With a top-emitting AM OLED display, AR can theoretically approach 100%, but is still limited by the ability to pattern all the necessary layers. That is, tolerance must be allowed between neighboring pixels for the maximum alignment error and minimum patterning resolution for each layer. This between- pixel region does not emit light and therefore lessens the AR. Many of these layers are typically patterned using photolithography techniques, which have good alignment and resolution. In the above-cited examples of organic EL devices, the organic EL materials must be patterned in order to produce multicolor devices, such as red-green-blue (RGB) displays. However, the organic materials used in organic EL films are typically incompatible with photolithography methods and therefore require other deposition techniques. For small molecule organic EL materials, the most common patterning method is deposition through a precision aligned shadow mask. Precision aligned shadow mask patterning, however, has relatively poor alignment and resolution compared to photolithography. Shadow mask patterning alignment becomes even more difficult when scaled up to larger substrate sizes. Therefore, the AR gain benefits from top-emitting AM device techniques cannot be fully realized using shadow masking. Furthermore, shadow mask patterning typically requires contact of the mask and substrate, which can cause defects such as scratching and reduce yield. Alignment of the shadow mask to the substrate also requires time, which reduces throughput and increases manufacturing equipment complexity.

A broadband light-emitting EL structure, such as a white light-emitting EL structure, can also be used to form a multicolor device. For such OLED devices, each pixel has a broad color emission, but is coupled with a color filter element as part of a color filter array (CFA) to achieve a pixilated multicolor display. A single organic EL layer is common to all pixels, and the color perceived by the viewer is dictated by that pixel's corresponding color filter element. Therefore, a multicolor or RGB device can be produced without requiring any patterning of the organic EL layers. Such white-light top-emitting AM displays with CFA's can offer superior AR, yield, and throughput compared to top-emitting AM displays with multicolor patterning. An example of a white CFA top-emitting device is shown in U.S. Pat. No. 6,392,340.

Color OLED displays have also recently been described that are constructed as to have four differently colored pixels. One type of such OLED display has pixels that are red, green, blue, and white in color and is known as an RGBW design. Examples of such four pixel displays are shown in U.S. Pat. No. 6,771,028; U.S. Patent Application Publications 2002/0186214 A1, 2004/0113875 A1, and 2004/0201558 A1. Such RGBW displays can be constructed using a white organic EL emitting layer with red, green, and blue color filters for the red, green, and blue pixels, respectively. The white pixel area is left unfiltered. Inclusion of the unfiltered white pixel allows for the display of colors that are less than fully saturated at reduced power consumption compared to similar RGB-only displays.

In order to reduce waste in manufacturing of OLED displays, it is often desirable to test the OLED display devices prior to completion. The devices are tested during the production process, and defective devices are discarded prior to the remaining manufacturing steps. Time and materials used in subsequent manufacturing steps are not wasted on defective devices and overall manufacturing cost is reduced. For example, it is desirable to test the active matrix circuitry prior to depositing the organic EL material. If defects occur during the fabrication of the active matrix circuitry components, these defective devices can be discarded and the organic EL materials can be conserved. Examples of such methods are described in U.S. Pat. No. 6,762,735 and in US Patent Application Publication No. 2004/0201372A1.

Similarly US Patent Application Publication No. 2002/0024051 by Yamazaki describes an OLED display having a color filter array, wherein the organic light-emitting device and the color filter array are separately manufactured on different substrates, and are then bonded so that the yields of the organic light emitting device and the color filter array do not affect each other. Organic EL materials are known to be sensitive to, and must be protected from, oxygen and moisture. Such OLED displays must be maintained in a controlled environment, such as a vacuum chamber, during manufacturing once the organic EL materials have been deposited until the OLED display is encapsulated or sealed. Yamazaki recognizes this need and provides a sealing member over the organic material prior to attaching the color filters.

This arrangement as taught by Yamazaki, however, has a problem in that at least one of the substrates is disposed between the emitting pixels and the filters. Since the substrates typically used for OLED devices are thick, such as 0.7 or 1.1 mm, the distance between the color filters and the emitting element is large relative to pixel size. Pixel cross-talk can occur whereby the light from one pixel travels at an angle and passes through the color filter of a neighboring pixel of a different color, reducing color purity. To reduce pixel cross-talk, the distance between the emitting element and the color filters must be reduced. In one embodiment, Yamazaki suggests using chemical mechanical polishing (CMP) to reduce the thickness of a substrate. However, CMP adds to manufacturing cost and is difficult to achieve as substrate size increases. Furthermore, even after CMP, the distance is still large resulting in substantial pixel cross-talk. Therefore, a method of manufacturing an OLED display with color filters having reduced costs is needed which reduces the above-mentioned difficulties and problems.

### SUMMARY OF THE INVENTION

It is therefore an object of the present invention to provide a method of manufacturing an OLED display having reduced waste, reduced cost, and improved throughput, and producing an OLED display having reduced pixel cross-talk.

This object is achieved by a method of fabricating a plurality of OLED devices, wherein each OLED device includes a light-producing unit and a color filter array unit, comprising:

a) providing a first substrate in a controlled environment and forming a plurality of light-producing units on a first side of such first substrate, with each light-producing unit having an array of pixels;

b) scribing under a controlled environment the first substrate to provide a plurality of individual light producing units;

c) testing under a controlled environment the plurality of light-producing units before or after scribing to identify acceptable light-producing units;

d) providing a second substrate having an acceptable color filter array unit formed on a first side of the second substrate;

e) bonding the acceptable color filter array unit to an acceptable individual light-producing unit to form a bonded unit such that the first side of the first substrate is adjacent to the first side of the second substrate; and

f) repeating steps d) and e) for each of the acceptable light-producing units to provide the plurality of OLED devices.

### ADVANTAGES

It is an advantage of this invention in that it reduces waste in time and material in the manufacture of OLED displays. It is a further advantage of this invention that it reduces pixel cross-talk in the resulting OLED displays relative to those prepared by prior art methods.

### BRIEF DESCRIPTION OF THE DRAWINGS

FIG. 1 shows a plan view of a first substrate with a plurality of light-producing units, each with an array of pixels that can be used in the practice of this invention;

FIG. 2 shows a plan view of a first substrate wherein a second substrate including a color filter array unit has been bonded to a plurality of light-producing units in accordance with this invention;

FIG. 3a shows a cross-sectional view of an OLED device prepared in accordance with this invention;

FIG. 3b shows a cross-sectional view of a portion of the above OLED device in greater detail;

FIG. 4 shows a controlled-environment system comprising a series of stations in accordance with the present invention;

FIG. 5 is a block diagram showing one embodiment of a method for fabricating a plurality of OLED devices in accordance with this invention;

FIG. 6 is a block diagram showing a portion of the embodiment of FIG. 5 in greater detail;

FIG. 7 is a block diagram showing a portion of the embodiment of FIG. 5 in greater detail;

FIG. 8 is a block diagram showing a portion of the embodiment of FIG. 5 in greater detail;

FIG. 9 is a block diagram showing another embodiment of a method for fabricating a plurality of OLED devices in accordance with this invention;

FIG. 10 is a block diagram showing another embodiment of a method for fabricating a plurality of OLED devices in accordance with this invention; and

FIG. 11 shows a plan view of a second substrate that includes a plurality of color filter array units.

Since device feature dimensions such as layer thicknesses are frequently in sub-micrometer ranges, the drawings are scaled for ease of visualization rather than dimensional accuracy.

### DETAILED DESCRIPTION OF THE INVENTION

The term “OLED device” or “organic light-emitting diode device” is used in its art-recognized meaning of a display device comprising organic light-emitting diodes as pixels. A color OLED device emits light of at least one color. The term “multicolor” is employed to describe a display panel that is capable of emitting light of a different hue in different areas. In particular, it is employed to describe a display panel that is capable of displaying images of different colors. These areas are not necessarily contiguous. The term “full color” is commonly employed to describe multicolor display panels that are capable of emitting in at least the red, green, and blue regions of the visible spectrum and displaying images in any combination of hues. The red, green, and blue colors constitute the three primary colors from which all other colors can be generated by appropriate mixing. However, the use of additional colors to extend the color gamut of the device is possible. For the purposes of this invention, each OLED device includes a light-producing unit and a color filter array unit whose natures will become evident. The term “pixel” is employed in its art-recognized usage to designate an area of a display panel that can be stimulated to emit light independently of other areas. It is recognized that in full-color systems, several pixels of different colors will be used together to generate a broad range of colors, and a viewer may term such a group a single pixel. For the purposes of this discussion, such a group will be considered several different colored pixels.

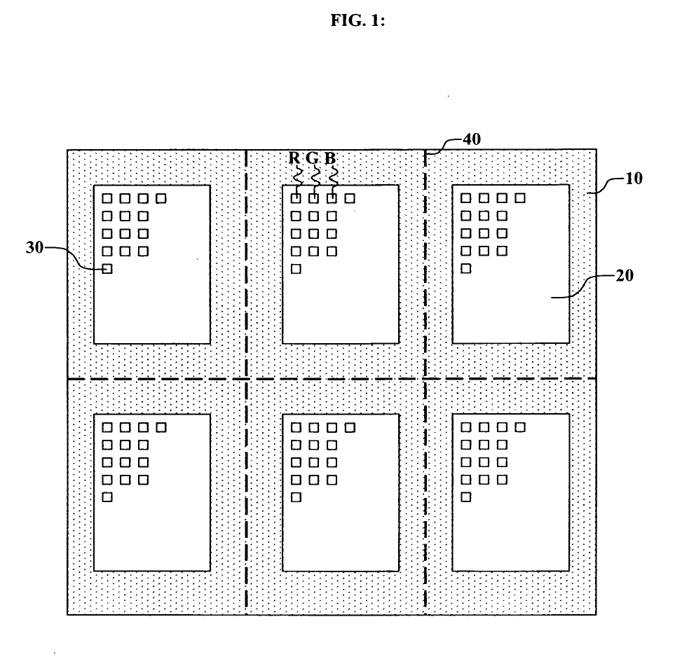

Turning now to FIG. 1, there is shown a plan view of a first substrate with a plurality of light-producing units, each with an array of pixels that can be used in the practice of this invention. First substrate 10 includes a plurality of light-producing units 20 formed on a first side of the substrate. Each of the light-producing units 20 has an array of pixels 30 so as to form the light-emitting portion of an OLED device well-known in the art. A number of arrangements of pixels are possible, as well-known in the prior art. FIG. 1 shows one possible arrangement of red, green, and blue pixels, labeled R, G, and B, respectively. It will be understood that pixels 30 themselves are not colored, but have the same broadband emission in this invention, e.g. white light. It is through the coupling with color filter array units through this invention that these pixels will become colored pixels, and therefore the circuitry and the driving logic must be designed for this. First substrate 10 will be scribed into individual light-producing units along scribing lines 40. This scribing can be effected before or after combining with a color filter array unit, as will be seen.

In the present invention, the light emission is viewed through the top electrode, so the transmissive characteristic of first substrate 10 is immaterial, and therefore can be light transmissive, light absorbing or light reflective. Substrates for use in this case include, but are not limited to, glass, plastic, semiconductor materials, ceramics, and circuit board materials, or any others commonly used in the formation of OLED devices, which can be either passive-matrix devices or active-matrix devices.

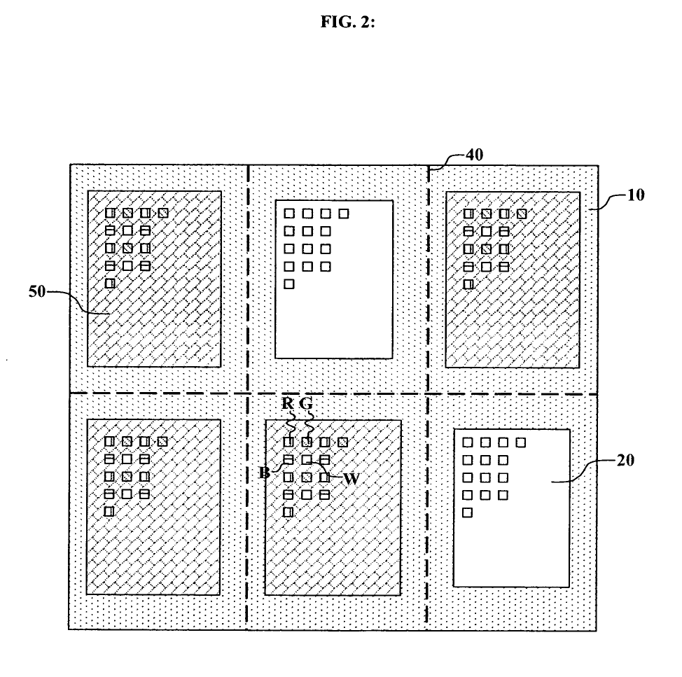

Turning now to FIG. 2, there is shown a plan view of a first substrate wherein a second substrate including a color filter array unit has been bonded to each of a plurality of light-producing units in accordance with this invention. A second substrate 50 has been bonded to each acceptable individual light-producing unit 20 on first substrate 10. The bonding can include a seal that prevents contamination of the light-producing device by oxygen or moisture. What comprises an acceptable light-producing unit and testing to determine which are acceptable will be discussed further below. Second substrate 50 has a color filter array unit formed on a first side, and the first side of second substrate 50 is bonded to the first side of first substrate 10. The color filter array can include any of a number of known color filter materials that selectively pass a portion of the visible light spectrum. The most common array comprises red, green, and blue filters. The arrangement wherein the first side of the first substrate, is adjacent to the first side of the second substrate, places the color filters in close proximity to the light-producing units, so as to reduce pixel cross-talk. The resulting arrangement will be referred to herein as a bonded unit, which after any required scribing is also an OLED device. The light transmissive property of second substrate 50 is desirable for viewing the light emission. Transparent glass or plastic are common materials for this substrate.

As shown in FIG. 2, several of the light-producing units 20 do not have second substrates 50 bonded to them. It is part of this invention to include testing the plurality of light-producing units to identify acceptable light-producing units. If necessary, the testing is done under a controlled environment, although some embodiments include an encapsulating layer that will permit testing outside of a controlled environment. Only acceptable light-producing units are bonded to second substrates. If the light-producing unit is found to be unacceptable, a second substrate is not bonded to it, thus preventing waste of second substrates 50 and their color filter array units.

To further prevent waste of acceptable light-producing units, it is also desired that the second substrates have acceptable color filter array units. Thus, it is desirable to test the color filter array units to identify acceptable color filter array units. Such testing can be a visual inspection or light-transmission measurement of the color filter array. Unacceptable color filter array units can be discarded without being bonded to a light-producing unit.

FIG. 2 shows another possible arrangement of pixels, wherein there are four different colored pixels, e.g. red, green, blue, and white. These are labeled R, G, B, and W, respectively. In this invention, the white pixels are preferably left unfiltered. Other arrangements of pixels as known in the art are also possible.

After second substrates 50 are bonded to first substrate 10, first substrate 10 can be scribed into individual bonded units, which comprise an acceptable light-producing unit and an acceptable color filter array unit, and unacceptable light-producing units, which are discarded. In alternative embodiments, first substrate 10 can be scribed into individual light-producing units before the bonding step. In such embodiments, the testing to identify acceptable light-producing units can be done before or after scribing. Acceptable light-producing units can be bonded to color filter array units, while unacceptable light-producing units can be discarded.

Although this method provides for bonding only acceptable light-producing units with acceptable color filter array units, it is possible for the bonded unit to be unacceptable due to undetected defects or defects produced during or after the bonding. Therefore, the bonded units can optionally be tested in another testing step to identify acceptable OLED devices. For example, power can be supplied to the bonded unit and the light output can be recorded.

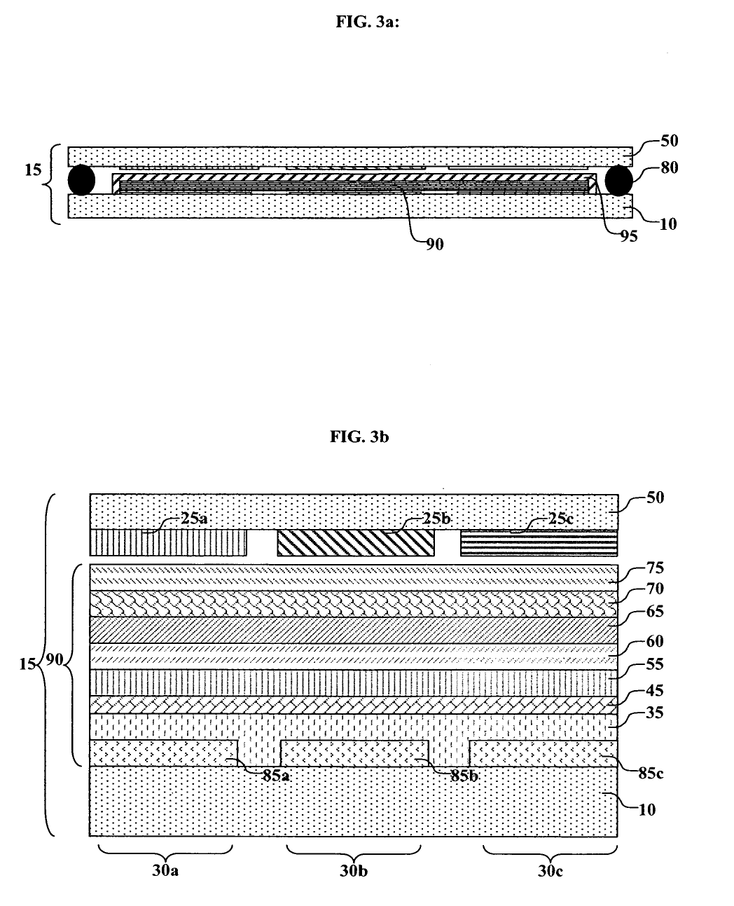

Turning now to FIG. 3a, there is shown a cross-sectional view of an OLED device prepared in accordance with this invention. OLED device 15 comprises first substrate 10 upon which OLED layers 90 have been formed to provide a light-producing unit. OLED layers 90 will be described further below. In some embodiments, encapsulating layer 95 can be provided over the light-producing unit, that is, covering and encapsulating OLED layers 90 to prevent contamination of the light-producing unit by oxygen or moisture. Encapsulating layer 95 can comprise organic, inorganic, or mixed organic and inorganic materials and can comprise a single layer or multiple layers of different materials or mixtures of materials. Example materials include aluminum oxide, silicon dioxide, titanium dioxide, zirconium dioxide, magnesium oxide, hafnium dioxide, tantalum oxide, aluminum titanium oxide, and tantalum hafnium oxide. Examples of encapsulating layers have been described by Ghosh et al. in US 2001/0052752 A1 and US 2002/0003403 A1, and by Winters et al. in U.S. patent application Ser. No. 11/116,743, filed Apr. 28, 2005. Second substrate 50 includes a color filter array unit and is bonded to first substrate 10 by seal 80. Seal 80 joins and holds the two substrates together and can also prevent contamination of the light-producing unit by oxygen or moisture. The material for seal 80 can be organic, inorganic, or a combination of organic and inorganic, and can include epoxies, polyurethanes, acrylates, silicones, glass, ceramic, metal, and metal solder, or combinations thereof. Examples of such sealing agents have been described in greater detail by Boroson in U.S. patent application Ser. No. 10/899,902, filed Jul. 27, 2004.

In other embodiments, encapsulating layer 95 is not used and seal 80 serves to prevent contamination. Turning now to FIG. 3b, there is shown a cross-sectional view in greater detail of a portion of OLED device 15 according to another embodiment, where the encapsulating layer is not used. The color filter array includes at least three separate filters, e.g. red color filter 25a, green color filter 25b, and blue color filter 25c, each of which forms part of a red 30a, green 30b, and blue 30c pixel respectively. Each pixel has its own anode 85a, 85b, and 85c, respectively, which are capable of independently causing emission of the individual pixel. Anodes 85a, 85b, and 85c are preferably reflective, but can be absorbing materials, e.g. aluminum or alloys thereof. The anodes can be part of a thin-film-transistor (TFT) circuitry system formed on first substrate 10 as part of an active-matrix device as known in the art. Although not shown, OLED device 15 can also include white pixels for which the corresponding area of second substrate 50 can be free of color filters. Color filters 25a, 25b, and 25c are formed on the first side of second substrate 50, OLED layers 90 are formed on the first side of first substrate 10, and the first sides of the two substrates are aligned so that they are adjacent.

Construction of various top-emitting OLED devices has been described in the art. Some examples are described here, but one skilled in the art will understand that there are numerous configurations of the OLED layers 90 wherein the present invention can be successfully practiced. Examples of organic EL media layers that produce white light are described, for example, in EP 1 187 235, US 2002/0025419, EP 1 182 244, US 5,683,823, US 5,503,910, US 5,405,709, and US 5,283,182. As shown in EP 1 187 235A2, a white light-emitting organic EL element with a substantially continuous spectrum in the visible region of the spectrum can be achieved by providing at least two different dopants for collectively emitting white light, e.g. by the inclusion of the following layers:

a hole-injecting layer 35 disposed over the anodes;

a hole-transporting layer 45 that is disposed over the hole-injecting layer 35 and is doped with a light-emitting yellow dopant for emitting light in the yellow region of the spectrum;

a blue light-emitting layer 55 including a host material and a light-emitting blue dopant disposed over the hole-transporting layer 45; and

an electron-transporting layer 65.

Because such an emitter produces a wide range of wavelengths, it can also be known as a broadband emitter and the resulting emitted light known as broadband light. The device further includes transparent upper electrode 75, and can include other layers, such as electron-injecting layer 70. Light provided by this light-producing unit is transmitted through transparent upper electrode 75 and second substrate 50.

Many materials used in OLED layer 90 are sensitive to contaminants such as oxygen or moisture, and must therefore be deposited in a controlled environment, and kept in such an environment until properly sealed. One example of a controlled environment is an environment having less than 133 Pascal partial pressure of water, less than 133 Pascal partial pressure of an oxidizing gas such as oxygen, or both. This can be achieved e.g. with a vacuum of less than 133 Pascal pressure, or by use of an inert gas such as nitrogen or argon.

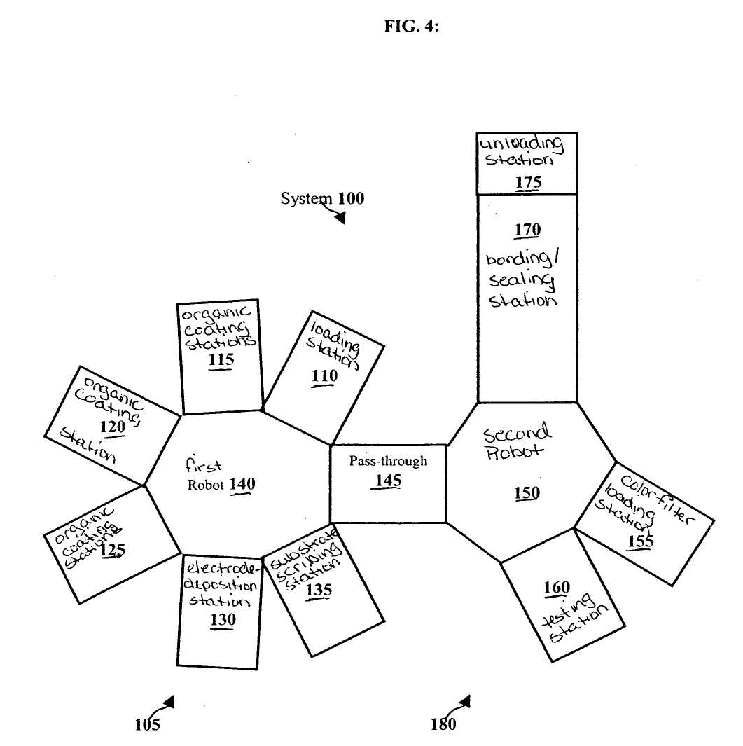

Turning now to FIG. 4, there is shown a controlled-environment system comprising a series of stations in accordance with the present invention. Controlled-environment system 100 combines deposition techniques with scribing and bonding, under a controlled environment for making OLED display devices such as described herein. Examples of similar systems have been described by Boroson et al. in U.S. Patent Publication No. 2004/0206307. System 100 comprises first cluster 105 and second cluster 180. First cluster 105 comprises robot 140 and the surrounding stations. Second cluster 180 comprises robot 150 and the surrounding stations. The nature of the surrounding stations will be further described. It will be evident to those skilled in the art that a variety of embodiments of system 100 are possible. For example, the entirety of system 100 can be enclosed in a controlled-environment chamber. In another embodiment, each station can be an individual controlled-environment chamber, in which case system 100 comprises first cluster 105 of controlled-environment chambers wherein robot 140 selectively positions first substrate 10 in the appropriate controlled-environment chamber, and second cluster 180 of controlled-environment chambers wherein robot 150 selectively positions first substrate 10 and second substrate 50 in the appropriate controlled-environment chamber. It will be understood that keeping the substrate in a controlled environment during the process can include a series of two or more different controlled-environment chambers. For example, first cluster 105 can be a vacuum environment, while second cluster 180 can be an inert gas environment at atmospheric pressure. In such a case, pass-through 145 will include a load lock to adjust pressure.

System 100 includes a loading station 110 that includes an appropriate set of robotics for automatically inserting first substrates 10 that comprise a plurality of light-producing units. Loading station 110 maintains a moisture-free environment and is further capable of being pumped down from atmospheric pressure to a vacuum condition that is appropriate for subsequent processing steps. In one embodiment, loading station 110 is a vacuum transport vessel that is capable of motion between the desired preprocessing stages, such as a circuitry-forming step, after which loading station 110 can be docked to system 100.

A first robot 140 is disposed with respect to the elements of system 100 such that it facilitates the time-efficient transport of first substrates 10 throughout the processing chambers while minimizing operator interface. System 100 can include a series of stations, e.g. organic coating stations 115, 120, and 125, in which organic layers such as continuous hole-transporting, light-emitting, and electron-transporting layers can be coated atop first substrate 10 using any of a variety of deposition techniques well-known in the art. System 100 can also include electrode-deposition station 130, in which a transparent upper electrode, such as a transparent indium-tin-oxide (ITO) anode, can be disposed onto first substrate 10.

System 100 further includes a substrate scribing station 135, in which first substrates 10 comprising a plurality of light-producing units are scribed into individual light-producing units. This particular embodiment of a controlled-environment system is therefore most useful for embodiments of this invention wherein the first substrate is scribed into individual light-producing units before bonding to color filter array units. Modifications to system 100 based on the principles of Boroson et al. can be used for other embodiments of this invention. For example, a scribing station that is part of second cluster 180 can be useful for embodiments wherein the first substrate is scribed after bonding. System 100 further includes a pass-through 145 that is a transport chamber that maintains a controlled environment and a second robot 150 that is another set of robotics disposed with respect to the elements of system 100 such that it facilitates the time-efficient transport of scribed substrates throughout the processing chambers while minimizing operator interface. Alternatively, pass-through 145 can be a transport vessel capable of motion for transporting first substrates 10 between two clusters that are physically separated. Each scribed substrate can be transferred to testing station 160 where it is subjected to testing under a controlled environment to determine if it is acceptable. In some cases, testing station 160 can include a window for testing the light-producing unit, so that the measuring equipment can be located exterior to testing station 160. The testing can be done in a number of ways. For example, power can be supplied to light-producing unit 20 and the light output can be recorded. Criteria such as unlit pixels or luminance uniformity can be measured and used to determine acceptability. Testing station 160 can include an unloading station for discarding unacceptable light-producing units. Acceptable light-producing units can be transferred by second robot 150 to bonding/sealing station 170.

System 100 includes color filter loading station 155 by which color filter array units are placed into the controlled environment of system 100. The color filter array units are transferred by second robot 150 to bonding/sealing station 170. The light-producing unit and the color filter array unit are aligned and bonded to each other to form a bonded unit as described above, and the bonded unit sealed at bonding/sealing station 170. Bonding and sealing processes are well-known in the art. Finally, system 100 includes an unloading station 175, in which the sealed bonded unit is withdrawn from system 100. Each of the chambers of system 100, while shown as if physically attached, can be connected by a vacuum transport chamber or translating vessel that maintains a controlled environment.

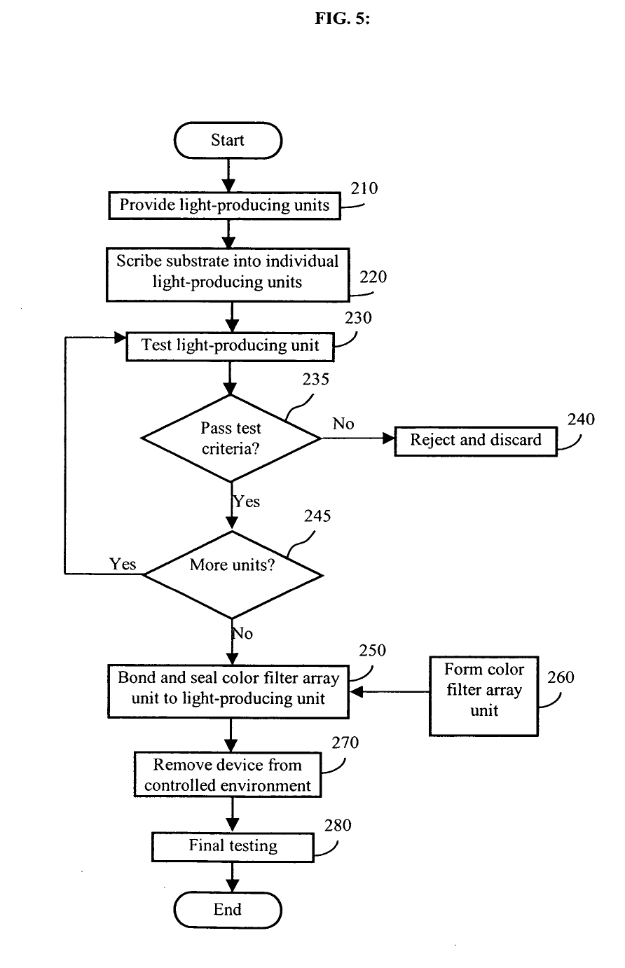

Turning now to FIG. 5, and referring also to FIG. 1, 2, and 4, there is shown a block diagram of one embodiment of a method for fabricating a plurality of OLED devices in accordance with this invention. First, a plurality of light-producing units 20 on a first substrate 10 is provided in a controlled environment, such as controlled environment system 100 (Step 210). Step 210 will be described in greater detail below. Substrate 10 is then scribed into a plurality of individual light-producing units 20 along scribing lines 40 (Step 220). This can be done at e.g. substrate scribing station 135. Scribing methods are well known in the art, e.g. a diamond or laser scribe for glass substrates.

The light-producing unit is then tested (Step 230), e.g. at testing station 160. If light-producing unit 20 does not pass the test criteria as described above (Step 235), it is rejected and discarded (Step 240). If it passes the test criteria, it is considered an acceptable light-producing unit and is used further. If there are more light-producing units to be tested (Step 245), Step 230 is repeated as necessary.

For each light-producing unit, an acceptable color filter array unit is provided that is formed on a first side of a second substrate 50 (Step 260). Step 260 will be described in greater detail below. The acceptable color filter array unit is bonded and sealed to the acceptable light-producing unit to form a bonded unit such that the first side of the first substrate is adjacent to the first side of the second substrate (Step 250). The bonding step can include forming a seal to prevent contamination of the light-producing unit by moisture, oxygen, or both. This step seals the light-producing unit from air and moisture contamination, and the bonded unit can be removed from the controlled environment (Step 270). Optionally, further testing can be done on the final OLED device (Step 280). Step 280 will be described in greater detail below.

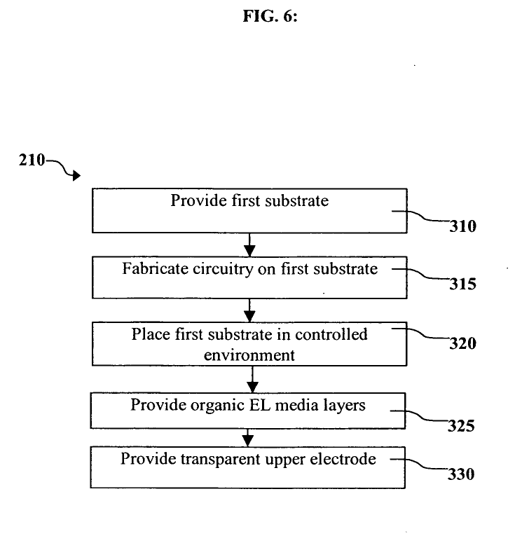

Turning now to FIG. 6, and referring also to FIG. 4, there is shown a block diagram of Step 210 of the embodiment of FIG. 5 in greater detail. A first substrate is provided (Step 310). Circuitry to provide the electrodes of the pixels of the light-producing units is then formed on the first substrate (Step 315). Active-matrix circuitry is preferred, but this invention is not limited to that arrangement and can be passive-matrix circuitry. Once the circuitry is provided, the substrate is placed into a controlled environment, e.g. controlled-environment system 100 of FIG. 4, via loading station 110 (Step 320). The various organic layers necessary to form an OLED device can be provided at coating stations, e.g. organic coating stations 115, 120, and 125 (Step 325). Finally, a transparent upper electrode can be provided, e.g. at electrode deposition station 130 (Step 330). These steps thus form a plurality of light-producing units on the first substrate.

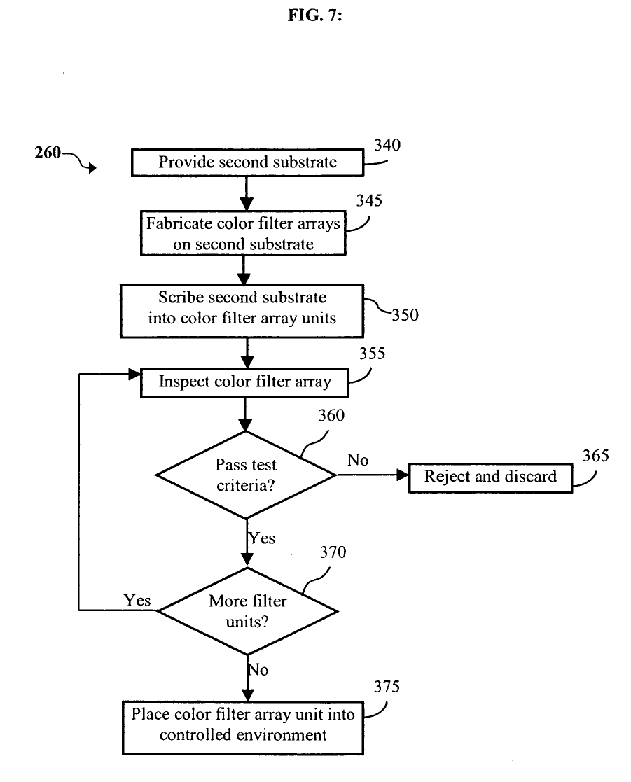

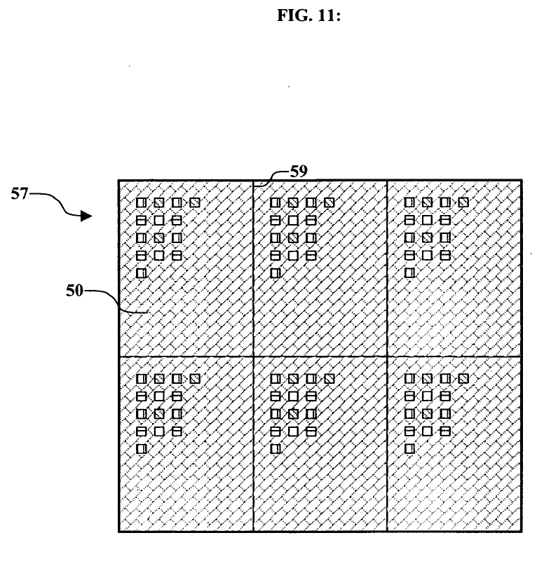

Turning now to FIG. 7, and referring also to FIG. 4, there is shown a block diagram of Step 260 of the embodiment of FIG. 5 in greater detail. A second substrate is provided (Step 340). This second substrate can be larger than the color filter array units of FIG. 2, and can be intended to have a plurality of color filter arrays, as shown by unified second substrate 57 of FIG. 11. A plurality of individual color filter arrays is then formed on the first side of unified second substrate (Step 345). Unified second substrate 57 is then scribed along scribing lines 59 to provide a plurality of individual color filter array units (Step 350). Each color filter array is then inspected or tested (Step 355). Test criteria can include transmittance/absorbance measurements of the color filters, or a visual inspection of the array for defects. If the color filter array does not pass the test criteria (Step 360), the unit is rejected and discarded (Step 365); otherwise, the color filter array unit is deemed an acceptable color filter array unit and continues in the process. If there are more color filter array units (Step 370), Step 355 is repeated as necessary. Acceptable color filter array units can then be placed into a controlled environment, e.g. controlled environment system 100 via color filter loading station 155 (Step 375).

Other arrangements of these steps are possible. For example, the color filter array can be inspected (Step 355) before scribing into individual color filter array units. In such a case, the unacceptable color filter array units can be marked or noted to be rejected once scribing into individual units is complete. Marking can be a physical mark, or the substrate ID and location can be retained electronically.

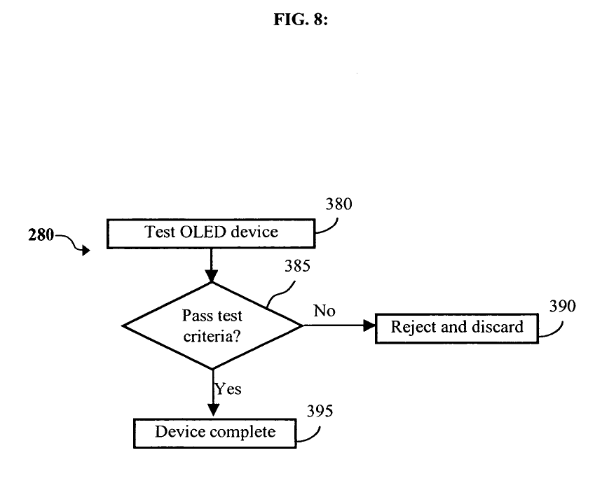

Turning now to FIG. 8, there is shown a block diagram of Step 280 of the embodiment of FIG. 5 in greater detail. After the individual bonded units are formed, they can be tested as a complete OLED device (Step 380). For example, power can be supplied to the bonded unit and the light output can be recorded. If the unit passes the test criteria (Step 385), it is considered complete and an acceptable OLED device (Step 395); if not, it is rejected and discarded (Step 390).

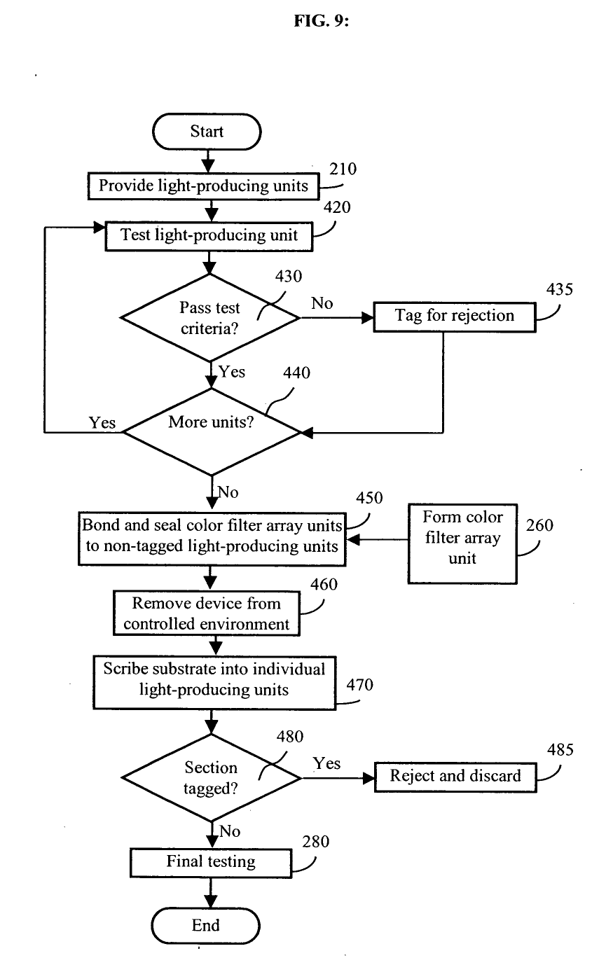

Turning now to FIG. 9, and referring also to FIG. 1 and 2, there is shown a block diagram of another embodiment of a method for fabricating a plurality of OLED devices in accordance with this invention. First, a plurality of light-producing units 20 on a first substrate 10 is provided in a controlled environment (Step 210, described in greater detail in FIG. 6). The light-producing units are then tested (Step 420). This testing can be done in a number of ways. For example, power can be supplied to light-producing unit 20 and the light output can be recorded. If light-producing unit 20 does not pass the test criteria (Step 430), it is tagged for rejection (Step 435), otherwise, it is considered an acceptable light-producing unit and is used further. If there are more light-producing units to be tested (Step 440), Step 420 is repeated as necessary.

A plurality of acceptable color filter array units are provided, each on a second substrate 50 (Step 260, described in greater detail in FIG. 7). The individual acceptable color filter array units are bonded and sealed to the acceptable (non-tagged) light-producing units on the first substrate to form a plurality of bonded units such that the first side of the first substrate is adjacent to the first side of the second substrate (Step 450). This step seals the acceptable light-producing units from air and moisture contamination, and the bonded unit can be removed from the controlled environment (Step 460). Substrate 10 is then scribed along scribing lines 40 into individual bonded units (OLED devices) and unacceptable light-producing units (Step 470). If the individual light-producing units are not acceptable and not bonded to a color filter array unit (Step 480), they are rejected and discarded (Step 485). If they are bonded units formed from acceptable light-producing units, they can optionally undergo final testing (Step 280) as described in FIG. 8.

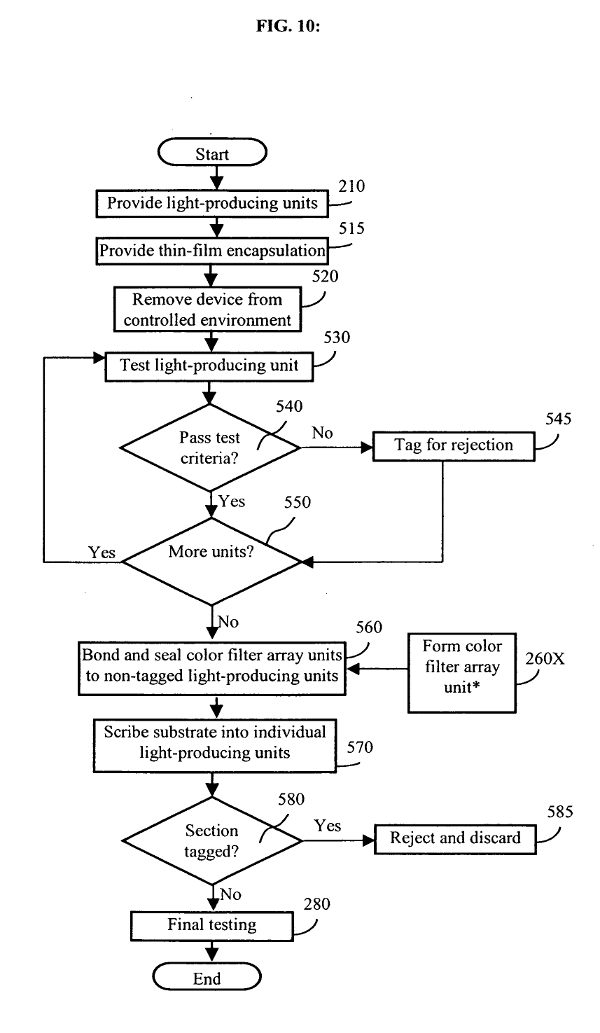

Turning now to FIG. 10, and referring also to FIG. 1 and 2, there is shown a block diagram of another embodiment of a method for fabricating a plurality of OLED devices in accordance with this invention. First, a plurality of light-producing units 20 formed on a first substrate 10 is provided in a controlled environment (Step 210, described in greater detail in FIG. 6). A thin-film encapsulating layer is then provided over the light-producing units (Step 515). This step seals the light-producing units from air and moisture contamination, and the substrate can be removed from the controlled environment (Step 520). The light-producing units are then tested (Step 530). If light-producing unit 20 does not pass the test criteria (Step 540), it is tagged for rejection (Step 545), otherwise, it is considered an acceptable light-producing unit and is used further. If there are more light-producing units to be tested (Step 550), Step 530 is repeated as necessary for the entire substrate.

A plurality of acceptable color filter array units is provided, each formed on a second substrate 50 (Step 260, as shown in FIG. 10, is described in greater detail in FIG. 7, except that placing the color filter array unit into a controlled environment—Step 375—is optional). The individual color filter array units are bonded and sealed to the acceptable (non-tagged) light-producing units on the first substrate to form a plurality of bonded units such that the first side of the first substrate is adjacent to the first side of the second substrate (Step 560). Substrate 10 is then scribed along scribing lines 40 into individual bonded units (OLED devices) and unacceptable light-producing units (Step 570). This can be done at e.g. substrate scribing station 135. If the individual light-producing units are not acceptable and not bonded to a color filter array unit (Step 580), they are rejected and discarded (Step 585). If they are bonded units formed from acceptable light-producing units, they can optionally undergo final testing (Step 280) as described in FIG. 8. This embodiment has the advantage that bonding, scribing, and testing—and the associated equipment—does not need to be in a controlled environment.

OLED device 15 can include layers commonly used for such devices. A bottom electrode is formed over OLED substrate 100 and is most commonly configured as an anode (e.g. 85a), although the practice of this invention is not limited to this configuration. As light emission is viewed through the top electrode, the transmissive characteristics of the anode material are immaterial and any conductive material can be used, transparent, opaque or reflective. Example conductors for this application include, but are not limited to, gold, iridium, molybdenum, palladium, platinum, aluminum or silver. Desired anode materials can be deposited by any suitable means such as evaporation, sputtering, chemical vapor deposition, or electrochemical means. Anode materials can be patterned using well known photolithographic processes.

While not always necessary, it is often useful that a hole-transporting layer 45 be formed and disposed over the anode. Desired hole-transporting materials can be deposited by any suitable means such as evaporation, sputtering, chemical vapor deposition, electrochemical means, thermal transfer, or laser thermal transfer from a donor material. Hole-transporting materials useful in hole-transporting layers are well known to include compounds such as an aromatic tertiary amine, where the latter is understood to be a compound containing at least one trivalent nitrogen atom that is bonded only to carbon atoms, at least one of which is a member of an aromatic ring. In one form the aromatic tertiary amine can be an arylamine, such as a monoarylamine, diarylamine, triarylamine, or a polymeric arylamine. Exemplary monomeric triarylamines are illustrated by Klupfel et al. in U.S. Pat. No 3,180,730. Other suitable triarylamines substituted with one or more vinyl radicals and/or comprising at least one active hydrogen-containing group are disclosed by Brantley et al. in U.S. Pat. Nos. 3,567,450 and 3,658,520.

A more preferred class of aromatic tertiary amines are those which include at least two aromatic tertiary amine moieties as described in U.S. Pat. Nos. 4,720,432 and 5,061,569. Such compounds include those represented by structural Formula A. 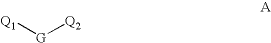
wherein:

Q₁ and Q₂ are independently selected aromatic tertiary amine moieties; and

G is a linking group such as an arylene, cycloalkylene, or alkylene group of a carbon to carbon bond.

In one embodiment, at least one of Q1 or Q2 contains a polycyclic fused ring structure, e.g., a naphthalene. When G is an aryl group, it is conveniently a phenylene, biphenylene, or naphthalene moiety.

A useful class of triarylamines satisfying structural Formula A and containing two triarylamine moieties is represented by structural Formula B. 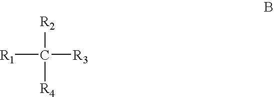
where:

R₁ and R₂ each independently represent a hydrogen atom, an aryl group, or an alkyl group or R₁ and R₂ together represent the atoms completing a cycloalkyl group; and

R₃ and R₄ each independently represent an aryl group, which is in turn substituted with a diaryl substituted amino group, as indicated by structural Formula C. 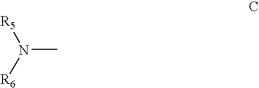
wherein R₅ and R₆ are independently selected aryl groups. In one embodiment, at least one of R₅ or R₆ contains a polycyclic fused ring structure, e.g., a naphthalene.

Another class of aromatic tertiary amines are the tetraaryldiamines. Desirable tetraaryldiamines include two diarylamino groups, such as indicated by Formula C, linked through an arylene group. Useful tetraaryldiamines include those represented by Formula D. 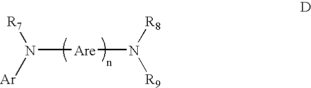
wherein:

each Are is an independently selected arylene group, such as a phenylene or anthracene moiety;

n is an integer of from 1 to 4; and

Ar, R₇, R₈, and R₉ are independently selected aryl groups.

In a typical embodiment, at least one of Ar, R₇, R₈, and R₉ is a polycyclic fused ring structure, e.g., a naphthalene.

The various alkyl, alkylene, aryl, and arylene moieties of the foregoing structural Formulae A, B, C, D, can each in turn be substituted. Typical substituents include alkyl groups, alkoxy groups, aryl groups, aryloxy groups, and halogens such as fluoride, chloride, and bromide. The various alkyl and alkylene moieties typically contain from 1 to about 6 carbon atoms. The cycloalkyl moieties can contain from 3 to about 10 carbon atoms, but typically contain five, six, or seven carbon atoms—e.g., cyclopentyl, cyclohexyl, and cycloheptyl ring structures. The aryl and arylene moieties are usually phenyl and phenylene moieties.

The hole-transporting layer in an OLED device can be formed of a single or a mixture of aromatic tertiary amine compounds. Specifically, one can employ a triarylamine, such as a triarylamine satisfying the Formula B, in combination with a tetraaryldiamine, such as indicated by Formula D. When a triarylamine is employed in combination with a tetraaryldiamine, the latter is positioned as a layer interposed between the triarylamine and the electron-injecting and transporting layer. The device and method described herein can be used to deposit single- or multi-component layers, and can be used to sequentially deposit multiple layers.

Another class of useful hole-transporting materials includes polycyclic aromatic compounds as described in EP 1 009 041. In addition, polymeric hole-transporting materials can be used such as poly(N-vinylcarbazole) (PVK), polythiophenes, polypyrrole, polyaniline, and copolymers such as poly(3,4-ethylenedioxythiophene)/poly(4-styrenesulfonate) also called PEDOT/PSS.

Light-emitting layers 55 and 60, as shown in FIG. 3b, produce light in response to hole-electron recombination. The light-emitting layers are commonly disposed over the hole-transporting layer. Desired organic light-emitting materials can be deposited by any suitable means such as evaporation, sputtering, chemical vapor deposition, electrochemical means, or radiation thermal transfer from a donor material. Useful organic light-emitting materials are well known. As more fully described in U.S. Pat. Nos. 4,769,292 and 5,935,721, the light-emitting layers of the OLED element comprise a luminescent or fluorescent material where electroluminescence is produced as a result of electron-hole pair recombination in this region. The light-emitting layers can be comprised of a single material, but more commonly include a host material doped with a guest compound or dopant where light emission comes primarily from the dopant. The dopant is selected to produce color light having a particular spectrum. The host materials in the light-emitting layers can be an electron-transporting material, as defined below, a hole-transporting material, as defined above, or another material that supports hole-electron recombination. The dopant is usually chosen from highly fluorescent dyes, but phosphorescent compounds, e.g., transition metal complexes as described in WO 98/55561, WO 00/18851, WO 00/57676, and WO 00/70655 are also useful. Dopants are typically coated as 0.01 to 10% by weight into the host material. The device and method described herein can be used to coat multi-component guest/host layers without the need for multiple vaporization sources.

Host and emitting molecules known to be of use include, but are not limited to, those disclosed in U.S. Pat. Nos. 4,768,292; 5,141,671; 5,150,006; 5,151,629; 5,294,870; 5,405,709; 5,484,922; 5,593,788; 5,645,948; 5,683,823; 5,755,999; 5,928,802; 5,935,720; 5,935,721; and 6,020,078. For this invention, it is particularly useful to provide two light-emitting layers of complementary color so that they produce a combined broadband emission.

Metal complexes of 8-hydroxyquinoline and similar derivatives (Formula E) constitute one class of useful host materials capable of supporting electroluminescence, and are particularly suitable for light emission of wavelengths longer than 500 nm, e.g., green, yellow, orange, and red. 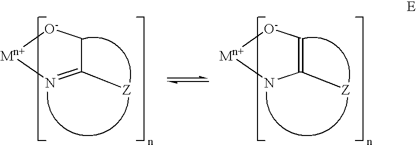
wherein:

M represents a metal;

n is an integer of from 1 to 3; and

Z independently in each occurrence represents the atoms completing a nucleus having at least two fused aromatic rings.

From the foregoing it is apparent that the metal can be a monovalent, divalent, or trivalent metal. The metal can, for example, be an alkali metal, such as lithium, sodium, or potassium; an alkaline earth metal, such as magnesium or calcium; or an earth metal, such as boron or aluminum. Generally any monovalent, divalent, or trivalent metal known to be a useful chelating metal can be employed.

Z completes a heterocyclic nucleus containing at least two fused aromatic rings, at least one of which is an azole or azine ring. Additional rings, including both aliphatic and aromatic rings, can be fused with the two required rings, if required. To avoid adding molecular bulk without improving on function the number of ring atoms is usually maintained at 18 or less.

The host material in the light-emitting layers can be an anthracene derivative having hydrocarbon or substituted hydrocarbon substituents at the 9 and 10 positions. For example, derivatives of 9,10-di-(2-naphthyl)anthracene constitute one class of useful host materials capable of supporting electroluminescence, and are particularly suitable for light emission of wavelengths longer than 400 nm, e.g., blue, green, yellow, orange or red.

Benzazole derivatives constitute another class of useful host materials capable of supporting electroluminescence, and are particularly suitable for light emission of wavelengths longer than 400 nm, e.g., blue, green, yellow, orange or red. An example of a useful benzazole is 2, 2′, 2″-(1,3,5-phenylene)tris [1-phenyl-1H-benzimidazole].

Desirable fluorescent dopants include perylene or derivatives of perylene, derivatives of anthracene, tetracene, xanthene, rubrene, coumarin, rhodamine, quinacridone, dicyanomethylenepyran compounds, thiopyran compounds, polymethine compounds, pyrilium and thiapyrilium compounds, derivatives of distryrylbenzene or distyrylbiphenyl, bis(azinyl)methane boron complex compounds, and carbostyryl compounds.

Other organic emissive materials can be polymeric substances, e.g. polyphenylenevinylene derivatives, dialkoxy-polyphenylenevinylenes, poly-para-phenylene derivatives, and polyfluorene derivatives, as taught by Wolk et al. in commonly assigned U.S. Pat. 6,194,119 B1 and references cited therein.

While not always necessary, it is often useful to include an electron-transporting layer 70, as shown in FIG. 3b, disposed over the light-emitting layers. Desired electron-transporting materials can be deposited by any suitable means such as evaporation, sputtering, chemical vapor deposition, electrochemical means, thermal transfer, or laser thermal transfer from a donor material. Preferred electron-transporting materials for use in the electron-transporting layer are metal chelated oxinoid compounds, including chelates of oxine itself (also commonly referred to as 8-quinolinol or 8-hydroxyquinoline). Such compounds help to inject and transport electrons and exhibit both high levels of performance and are readily fabricated in the form of thin films. Exemplary of contemplated oxinoid compounds are those satisfying structural Formula E, previously described.

Other electron-transporting materials include various butadiene derivatives as disclosed in U.S. Pat. No. 4,356,429 and various heterocyclic optical brighteners as described in U.S. Pat. No. 4,539,507. Certain benzazoles are also useful electron-transporting materials. Other electron-transporting materials can be polymeric substances, e.g. polyphenylenevinylene derivatives, poly-para-phenylene derivatives, polyfluorene derivatives, polythiophenes, polyacetylenes, and other conductive polymeric organic materials known in the art.

A transparent upper electrode 75, as shown in FIG. 3b, most commonly configured as a cathode is formed over the electron-transporting layer, or over the light-emitting layers if an electron-transporting layer is not used. The electrode must be transparent or nearly transparent. For such applications, metals must be thin (preferably less than 25 nm) or one must use transparent conductive oxides (e.g. indium-tin oxide, indium-zinc oxide), or a combination of these materials. Optically transparent cathodes have been described in more detail in U.S. Pat. 5,776,623. Cathode materials can be deposited by evaporation, sputtering, or chemical vapor deposition. When needed, patterning can be achieved through many well known methods including, but not limited to, through-mask deposition, integral shadow masking as described in U.S. Pat. No. 5,276,380 and EP 0 732 868, laser ablation, and selective chemical vapor deposition.

OLED device 15 can include other layers as well. For example, a hole-injecting layer 35 can be formed over the anode, as described in U.S. 4,720,432, U.S. 6,208,075, EP 0 891 121 A1, and EP 1 029 909 A1. An electron-injecting layer 70, such as alkaline or alkaline earth metals, alkali halide salts, or alkaline or alkaline earth metal doped organic layers, can also be present between the cathode and the electron-transporting layer.

The invention has been described in detail with particular reference to certain preferred embodiments thereof, but it will be understood that variations and modifications can be effected within the spirit and scope of the invention.

### Parts List

10 first substrate
15 OLED device
20 light-producing unit
25a red color filter
25b green color filter
25 c blue color filter
30 pixel
30a red pixel
30b green pixel
30c blue pixel
35 hole-injecting layer
40 scribing line
45 hole-transporting layer
50 second substrate
55 light-emitting layer
57 unified second substrate
59 scribing line
60 light-emitting layer
65 electron-transporting layer
70 electron-injecting layer
75 transparent upper electrode
80 seal
85a anode
85b anode
85c anode
90 OLED layers
95 encapsulating layer
100 system
105 first cluster
110 loading station
115 organic coating station
120 organic coating station
125 organic coating station
130 electrode deposition station
135 substrate scribing station
140 first robot
145 pass-through
150 second robot
155 color filter loading station
160 testing station
170 bonding/sealing station
175 unloading station
180 second cluster
210 step
220 step
230 step
235 decision step
240 step
245 decision step
250 step
260 step
270 step
280 step
310 step
315 step
320 step
325 step
330 step
340 step
345 step
350 step
355 step
360 decision step
365 step
370 decision step
375 step
380 step
385 decision step
390 step
395 step
420 step
430 decision step
435 step
440 decision step
450 step
460 step
470 step
480 decision step
485 step
515 step
520 step
530 step
540 decision step
545 step
550 decision step
560 step
570 step
580 decision step
585 step

What is claimed is:

1. A method of fabricating a plurality of OLED devices, wherein each OLED device includes a light-producing unit and a color filter array unit, comprising:
a) providing a first substrate in a controlled environment and forming a plurality of light-producing units on a first side of such first substrate, with each light-producing unit having an array of pixels;
b) scribing under a controlled environment the first substrate to provide a plurality of individual light-producing units;
c) testing under a controlled environment the plurality of light-producing units before or after scribing to identify acceptable light-producing units;
d) providing a second substrate having an acceptable color filter array unit formed on a first side of the second substrate;
e) bonding the acceptable color filter array unit to an acceptable individual light-producing unit to form a bonded unit such that the first side of the first substrate is adjacent to the first side of the second substrate; and
f) repeating steps d) and e) for each of the acceptable light-producing units to provide the plurality of OLED devices.

2. The method of claim 1 wherein the bonding step includes forming a seal to prevent contamination of the light-producing unit.

3. The method of claim 1 wherein each light-producing unit includes active-matrix circuitry formed on the first substrate.

4. The method of claim 1 wherein each light-producing unit includes a transparent upper electrode and light provided by such unit is transmitted through the second substrate and the transparent upper electrode.

5. The method of claim 1 further including testing color filter array units to identify acceptable color filter array units.

6. The method of claim 1 further including testing the bonded units to identify acceptable OLED devices.

7. In a method of fabricating a plurality of OLED devices, wherein each OLED device includes a light-producing unit and a color filter array unit, comprising:
a) providing a first substrate in a controlled environment and forming a plurality of light-producing units on a first side of such first substrate, with each light-producing unit having an array of pixels;
b) testing under a controlled environment the plurality of light-producing units to identify acceptable light-producing units;
c) providing a plurality of second substrates, each having an acceptable color filter array unit formed on a first side of the second substrate;
d) bonding the individual acceptable color filter array units to acceptable light-producing units on the first substrate to form bonded units such that the first side of the first substrate is adjacent to the first side of the second substrate; and
e) scribing the bonded units to provide the plurality of OLED devices.

8. The method of claim 7 wherein the bonding step includes forming a seal to prevent contamination of the light-producing unit.

9. The method of claim 7 wherein each light-producing unit includes active-matrix circuitry formed on the first substrate.

10. The method of claim 7 wherein each light-producing unit includes a transparent upper electrode and light provided by such unit is transmitted through the second substrate and the transparent upper electrode.

11. The method of claim 7 further including testing color filter array units to identify acceptable color filter array units.

12. The method of claim 7 wherein one second substrate is provided with a plurality of color filter arrays and is scribed to provide a plurality of individual color filter array units.

13. The method of claim 12 further including testing the color filter array units before or after scribing to identify acceptable color filter array units.

14. The method of claim 7 further including testing the bonded unit after scribing to identify acceptable OLED devices.

15. In a method of fabricating a plurality of OLED devices, wherein each OLED device includes a light-producing unit and a color filter array unit, comprising:
a) providing a first substrate in a controlled environment and forming a plurality of light-producing units on a first side of such first substrate, with each light-producing unit having an array of pixels;
b) providing an encapsulating layer over the light-producing unit;
c) testing the plurality of light-producing units to identify acceptable light-producing units;
d) providing a plurality of second substrates, each having an acceptable color filter array unit formed on a first side of the second substrate;
e) bonding the individual acceptable color filter array units to acceptable light-producing units on the first substrate to form bonded units such that the first side of the first substrate is adjacent to the first side of the second substrate; and
f) scribing the bonded units to provide the plurality of OLED devices.

16. The method of claim 15 wherein the bonding step includes forming a seal to prevent contamination of the light-producing unit.

17. The method of claim 15 wherein each light-producing unit includes active-matrix circuitry formed on the first substrate.

18. The method of claim 15 wherein each light-producing unit includes a transparent upper electrode and light provided by such unit is transmitted through the second substrate and the transparent upper electrode.

19. The method of claim 15 further including testing color filter array units to identify acceptable color filter array units.

20. The method of claim 15 wherein one second substrate is provided with a plurality of color filter arrays and is scribed to provide a plurality of individual color filter array units.

21. The method of claim 20 further including testing the color filter array units before or after scribing to identify acceptable color filter array units.

22. The method of claim 15 further including testing the bonded unit after scribing to identify acceptable OLED devices.
